(19) United States
(12) Patent Application Publication
(10) Pub. No.: US 2025/0248468 A1
(43) Pub. Date: Aug. 7, 2025

(54) Magnetic Pocket for Mobile Devices

(71) Applicant: Ryan David Zimbauer, San Jose, CA (US)

(72) Inventor: Ryan David Zimbauer, San Jose, CA (US)

(21) Appl. No.: 19/046,802

(22) Filed: Feb. 6, 2025

Related U.S. Application Data
(60) Provisional application No. 63/550,281, filed on Feb. 6, 2024.

(51) Int. Cl. A41D 27/20; H02J 50/12; H02J 50/90

(52) U.S. Cl. CPC A41D 27/205; H02J 50/12; H02J 50/90

(57) ABSTRACT

A magnetic pocket for mobile devices (MPMD) includes a pocket-equipped article. The MPMD includes a pocket disposed on the pocket-equipped article. The pocket includes a top part and a bottom part. The top part of the pocket includes an opening. The MPMD includes a magnet. The magnet is enclosed in a material. The material fully covers the magnet. The material is removably attached to the pocket disposed on the pocket-equipped article.

### PRIORITY NOTICE

This application claims priority to U.S. Patent Application No. 63/550,281, entitled “Wearable Charger,” filed on Feb. 6, 2024, which is incorporated by reference in its entirety.

### BACKGROUND

Mobile devices, such as smartphones, have become indispensable tools for modern life, accompanying users throughout daily activities. As these devices grow in size and value, the need for secure storage during movement has increased. Traditionally, clothing pockets have served as a convenient location to carry such devices. However, many existing pocket designs fail to adequately secure mobile devices during dynamic activities such as walking, running, or bending. This often results in devices slipping out, leading to potential damage, loss, or inconvenience.

### BRIEF DESCRIPTION OF THE DRAWINGS

A greater appreciation of the nonobvious innovations and the resultant new, unexpected advantages provided by various embodiments of the present disclosure is realized by reference to the following drawing figures, their descriptions, and respective reference numerals. Similar or interchangeable elements may have the same reference numerals or be cross-referenced in this specification and the appended drawing figures. The appended drawing figures are provided by way of illustration for exemplification only and are not to be interpreted as a definition or limit of other embodiments described herein or the scope of the claims.

FIG. 1 is a perspective view illustrating one example of a pocket-equipped article including an magnetic pocket for mobile devices (MPMD).

FIG. 2 is a cutaway side view illustrating an example MPMD.

FIG. 3 is a front view illustrating an example embodiment of a pocket-equipped article including one or more MPMDs that are a cargo or welt pocket or a typical front pocket.

FIG. 4 is a cutaway side view illustrating an example MPMD that is permanently affixed to the exterior fabric of an pocket-equipped article.

FIG. 5 is a cutaway side view illustrating an example MPMD that is affixed to the exterior fabric of an pocket-equipped article after the pocket-equipped article's manufacture.

### SUMMARY OF THE INVENTION

One aspect of the present disclosure is a magnetic pocket for mobile devices (MPMD). The MPMD may include a pocket-equipped article. The MPMD may include a pocket disposed on the pocket-equipped article. The pocket may include a top part and a bottom part. The top part of the pocket may include an opening. The MPMD may include a magnet. The magnet may be enclosed in a material. The material may fully cover the magnet. The material may be removably or permanently attached to the pocket disposed on the pocket-equipped article. A MPMD may include a charging apparatus. The charging apparatus may magnetically attach to the magnet.

### DETAILED DESCRIPTION

The limitations of conventional pockets for holding mobile devices stem from the pockets' basic design, which often prioritizes style or general functionality over secure storage. Many pockets are shallow or lack features to restrain the movement of items, particularly slim, smooth devices like smartphones. Moreover, some pockets are positioned in areas of clothing that are subject to frequent movement or pressure, further exacerbating the risk of items falling out.

To address these challenges, various solutions have been attempted, including deeper pockets, the addition of closures such as zippers or buttons, and the integration of external pouches or clips. While these approaches provide incremental improvements, they often compromise user convenience, aesthetics, or the versatility of the clothing.

The systems, solutions, devices, assemblies, configurations, and methods/processes of use of the present disclosure solve these and other limitations and shortcomings of existing conventional systems and solutions.

The present disclosure is directed toward a magnetic pocket for mobile devices (MPMD) and methods of use thereof. Specifically, the present disclosure demonstrates at least the novel, nonobvious construction of a magnetic pocket capable of magnetically attaching to a mobile device to better secure the mobile device to the mobile device carrier, make a more effective electrical connection between the phone and the charging apparatus, improve electronic inductive resonance, provide stability and security to the connection, and cause the mobile device and the charger to be concentric one with another.

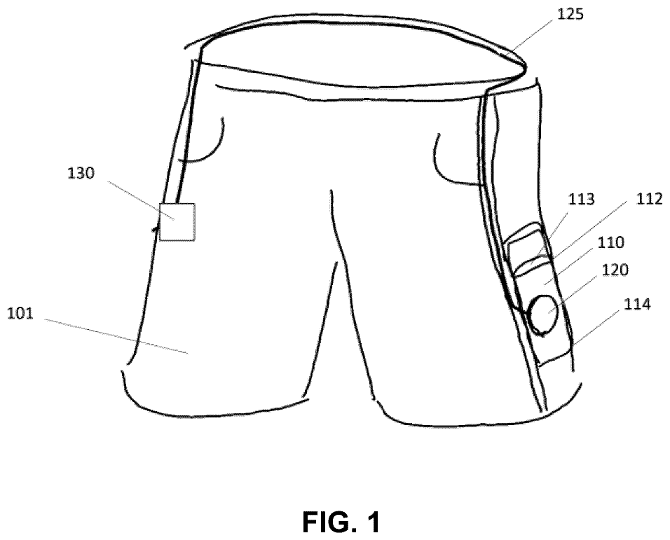

FIG. 1 depicts an example embodiment of a pocket-equipped article including a MPMD. According to FIG. 1, a MPMD may include a pocket 110 sewn onto a pocket-equipped article 101. The pocket 110 may include a top part 112 and a bottom part 114. The top part 112 of the pocket 110 may include an opening 113. In one embodiment, the opening 113 is disposed on the top part 112 of the pocket, and a wearer of the pocket-equipped article 101 may insert a mobile device into the pocket 110 through the opening 113.

In some embodiments, the pocket 110 may include a charging apparatus 120. In some embodiments, the pocket 110 may include a channel 125. The channel 125 may connect the charging apparatus to an energy source 130. The channel 125 may include electrical wires encased in a flexible sheath capable of withstanding machine wash cycles. In one embodiment, the channel 125 may include copper or aluminum wires encased in a polycarbonate plastic, a polycarbonate-acrylonitrile butadiene styrene blend, or other materials. The channel 125 may include a voltage regulator or a circuit board with electronics that control power flow.

In one embodiment, the channel 125 may travel through pocket-equipped article 101. At least a portion of the channel 125 may be visible on an outside layer of the pocket-equipped article 101. In some embodiments, the channel 125 may be entirely hidden and travel entirely inside the pocket-equipped article 101. The energy source 130 may be located on an interior portion of pocket-equipped article 101. The channel 125 may also travel through belt loops of the pocket-equipped article 101. The channel 125 may travel any length and/or distance and on any path through, around, under, over, and about the pocket-equipped article 101. The channel 125 may connect the charging apparatus 120 to the energy source 130.

In one or more embodiments, the energy source 130 may be located in an additional pocket of the pocket-equipped article 101 (not shown in FIG. 1). The additional pocket may hold the energy source 130 and may be sewn onto the pocket-equipped article 101. The energy source 130 may be any energy source capable of providing power to the charging apparatus 120. For example, the energy source 130 may include a battery.

In some embodiments, the pocket-equipped article 101 may include a backpack, a purse, a handbag, or some other article capable of being equipped with a pocket.

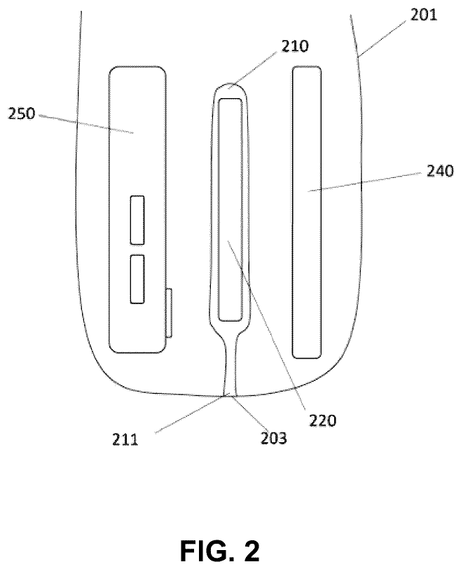

FIG. 2 depicts an example embodiment of an MPMD. According to FIG. 2, some embodiments of the present disclosure may include a pocket 201. The pocket 201 may include the pocket 110 of FIG. 1. The pocket 201 may include a sub-pocket 210 on an interior of the pocket 201. The sub-pocket 210 may include a flap of fabric or an enclosed material on an inside portion of the pocket 201. The sub-pocket 210 may include any material and may include the same material as the pocket 201. The sub-pocket 210 may include a heat insulating material such as Aerogel-infused fabrics, neoprene, aluminized mylar, Teflon coatings, silicone, or some other material capable of insulating heat. The sub-pocket 210 may include an electrical insulating material silicone, woven fiberglass, wool, polyurethane or some other material capable of providing electrical insulation. The sub-pocket 210 may include a waterproof material such as nylon, polyester, PVC-coated fabric, waterproof coating, or some other material capable of preventing water passing through a fabric.

In one embodiment, the sub-pocket 210 may divide the pocket 201 into two sections, an upper and a lower section, or an inner section and an outer section. The sub-pocket 210 may contain, on an interior of the sub-pocket 210, a magnet 220. In some embodiments, the pocket 201 may include a charging apparatus 240. The pocket 201 may be configured to receive a mobile device 250 and may further be configured to receive a charging apparatus 240. The charging apparatus 240 may include the charging apparatus 120 of FIG. 1. The magnet 220 may concentrically align the charging apparatus 240 with the mobile device 250 such that an effective electrical connection is made between the mobile device 250 and the charging apparatus 240. The magnet 220 may facilitate an effective charging of the mobile device 250.

The sub-pocket 210 may be inside of the pocket 201 and may fully cover the magnet 220. The sub-pocket 210 may have a bottom part 211 that is connected to a bottom part 203 of the pocket 201.

The charging apparatus 240 may magnetically connect with the magnet 220 that is inside the sub-pocket 210. The mobile device 250 may magnetically connect with the magnet 220 when the mobile device 250 is disposed within the pocket 201. In some embodiments, the magnet 220 may lock the mobile device 250 and the charging apparatus 240 into place. This may beneficially improve stability of the connection and a faster rate of charging. This may also improve security of the mobile device 250 and reduce damage received from potential falls of the mobile device 250.

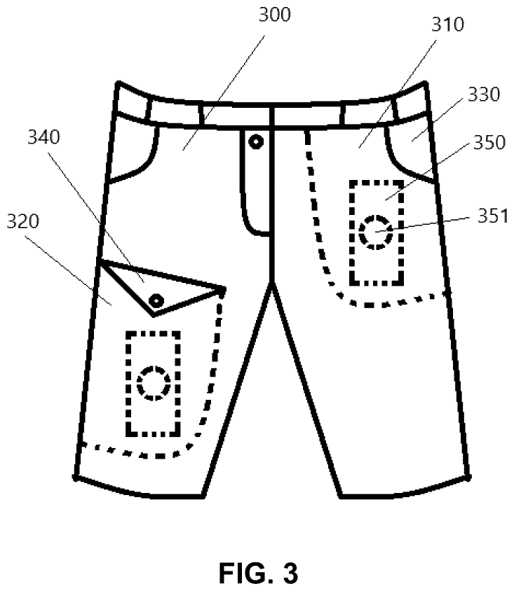

FIG. 3 depicts an example embodiment of a pocket-equipped article including one or more MPMDs. FIG. 3 shows a front view of a pocket-equipped article 300. The pocket-equipped article may include two pockets, a first pocket 310 and a second pocket 320. The first pocket 310 may include a slant, slash, western, or inset pocket. The second pocket 320 may include a cargo or welt pocket located anywhere on the pocket-equipped article 300.

The first pocket 310 may include a top opening 330. The top opening 330 may include an opening disposed on a top part of the first pocket 310. A user (e.g., a wearer of the pocket-equipped article 300) may insert a mobile device 350 with an integrated magnet 351 into the first pocket 310 through the top opening 330.

The second pocket 320 may include a top opening 340. The top opening 340 may include an opening disposed on a top part of the second pocket 320. The second pocket 320 may include a flap or button clasp that can cover the top opening 340. A user may lift the flap or button clasp to expose the top opening 340 and may insert a mobile device 350 with an integrated magnet 351 into the second pocket through the top opening 340.

In some embodiments, the pocket-equipped article 300 may include an article of clothing, a backpack, a purse, a handbag, or some other article capable of being equipped with one or more pockets.

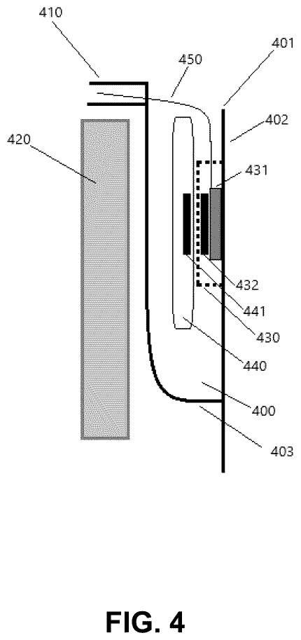

FIG. 4 depicts an example embodiment of a MPMD. In one embodiment, a pocket 400 is disposed on a pocket-equipped article 410. The pocket 400 may include the first pocket 310 or the second pocket 320 of FIG. 3. The pocket 400 may rest against the wearer's body 420. The pocket 400 may include a top opening 401, an exterior fabric 402, and/or an interior fabric 403. The top opening 401 may be an edge or slit through which items are inserted or removed from the pocket 400. The exterior fabric may be the visible, exterior-facing fabric that forms the outer shell of the pocket 400. The interior fabric may be the lining fabric that rests on the wearer's body 420.

In some embodiments, the pocket 400 may include a sub-pocket 430. The sub-pocket 430 may be permanently affixed to the exterior fabric 402 of the pocket 400. The sub-pocket 430 may include or be made of the same material as the exterior fabric 402, the same material as the interior fabric 403, a silicone, or another different fabric.

In one embodiment, the sub-pocket 430 may be disposed on the exterior fabric 402 via sewing stitches, iron-on adhesive, rivets, glue, adhesive, stapling, hook-and-loop, snap fasteners, grommets and lacing, zippers, pins, clips, magnets, buttons, or hooks.

The sub-pocket 430 may include a wireless charger 431. The wireless charger 431 may include an integrated magnet. The wireless charger 431 may be disposed on the interior of the sub-pocket 430. The wireless charger 431 may be disposed on the side of the sub-pocket 430 closest to the exterior fabric 402. The sub-pocket 430 may include a magnet 432 disposed on the interior of the sub-pocket 430. The magnet 432 may be disposed on the side of the sub-pocket 430 closest to the wearer's body 420.

In some embodiments, the sub-pocket 430 may be disposed on the interior fabric 403. In such embodiments, the sub-pocket 430 further includes a wireless charger 431, with an integrated magnet. The wireless charger 431 may be disposed to the interior of the sub-pocket 430 on the side closest to the wearer's body 420. A magnet 432 may be disposed on the interior of the sub-pocket 430 on the side closes to the exterior fabric 402.

In some embodiments, the magnet 432 may include a magnetic ring. This allows the magnet 432 to improve electronic inductive resonance between a charging apparatus (e.g., the wireless charger 431) and a mobile device disposed in the pocket 400.

A mobile device 440 may be inserted into the pocket 400 via the top opening 401. A magnet 441 integrated with the mobile device 440 can align with the magnet 432 affixed to the interior of the sub-pocket 430 to generate an attractive force that can cause the mobile device 440 to be secured inside the pocket 400 and be charged via the wireless charger 431.

In some embodiments, a channel 450 can connect the wireless charger 431 to an energy source (e.g., a battery, not shown in FIG. 4). The channel 450 may be similar to the channel 125 of FIG. 1, described above. The channel 450 may be visible on the outside layer of the pocket-equipped article 410. The channel 450 may be entirely hidden and travel inside the pocket-equipped article 410. The channel 450 may also travel through belt loops of the pocket-equipped article 410. The channel 450 may travel and length and/or distance and on any path through, around, under, over, and about the pocket-equipped article 410.

In some embodiments, the sub-pocket 430 may not include the wireless charger 431 with an integrated magnet but may include the magnet 432 without the wireless charger 431. The magnet 432 may be disposed on the interior of the of the sub-pocket 430 on the side closest to the wearer's body 420.

In some embodiments, the pocket-equipped article 410 may include an article of clothing, a backpack, a purse, a handbag, or another article capable of being equipped with one or more pockets.

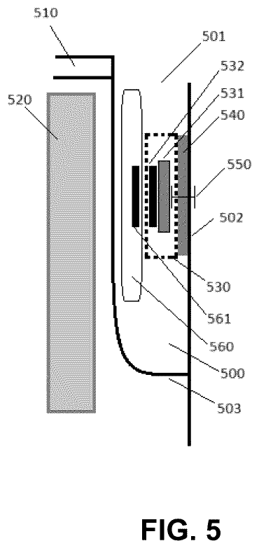

FIG. 5 depicts an example embodiment of a MPMD. In one embodiment, a pocket 500 may be disposed on a pocket-equipped article 510. The pocket 500 may include the first pocket 310 or the second pocket 320 of FIG. 3. The pocket 500 may include a top opening 501, an exterior fabric 502, and/or an interior fabric 503 that rests against the wearer's body 520.

In one embodiment, the pocket 500 may include a sub-pocket 530. The sub-pocket 530 is removably disposed on the exterior fabric 502 of the pocket 500. The sub-pocket 530 may include or be made of the same material as the exterior fabric 502, the same material as the interior fabric 503, a silicone, or another fabric.

The sub-pocket 530 may be removably disposed on the exterior fabric 502 via sewing stitches, iron-on adhesive, rivets, glue, adhesive, stapling, hook-and-loop, snap fasteners, grommets and lacing, zippers, pins, clips, magnets, buttons, or hooks.

In some embodiments, a webbing interface 540 may be disposed on the sub-pocket 530 to assist the user with affixing the sub-pocket 530 to the exterior fabric 502. The webbing interface 540 may include nylon, polyester, cotton, polypropylene, hook-and-loop, or Kevlar. In some embodiments, the webbing interface 540 may be disposed on the exterior fabric 502 to assist the user with affixing the sub-pocket 530 to the exterior fabric 502. In one embodiment, the webbing interface is disposed on the interior fabric 503 so that the sub-pocket 530 may be affixed to the interior fabric 503 instead of the exterior fabric 502.

In some embodiments, a removable pin and backer 550 may be disposed through one layer of the sub-pocket 530 and disposed through the exterior fabric 502. The removable pint and backer 550 may disposed the sub-pocket 530 on the exterior fabric 502 at a chosen location on the pocket-equipped article 510. In another embodiment, the removable pin and backer 550 may be disposed through one layer of the sub-pocket 530 and disposed through the interior fabric 503 to dispose the sub-pocket 530 on the interior fabric 503 at a chosen location on the pocket-equipped article 510. In some embodiments, the removable pin and backer 550 may include a permanent rivet or garter-style button and hook and may dispose the sub-pocket 530 on the exterior fabric 502 or the interior fabric 503.

In one embodiment, the sub-pocket 530 may include a wireless charger 531. The wireless charger 531 may include an integrated magnet disposed on the interior of the sub-pocket 530 on the side closest to the exterior fabric 502. The sub-pocket 530 may include a magnet 532 disposed on the interior of the sub-pocket 530 on the side closest to the wearer's body 520. In some embodiments, the magnet 532 may include a magnetic ring. This configures the connection between the magnet 532 and a mobile device 560 to facilitate the electronic connection, improve electronic inductive resonance, provide stability and security to the connection, or cause the wireless charger 531 and the mobile device 560 to be concentric one with another.

The sub-pocket 530 may fully cover the magnet 532 and may augment the friction experienced by the wireless charger 531 and the mobile device 560. The sub-pocket 530 may be waterproof.

In one embodiment, the mobile device 560 is inserted into the pocket 500 via the top opening 501. A magnet 561 integrated with the mobile device 560 may align with the magnet 532 disposed on the interior of the sub-pocket 530 to generate an attractive force that can cause the mobile device 560 to be secured inside the pocket 500 and be charged via the wireless charger 531.

In some embodiments, the sub-pocket 530 may not include the wireless charger 531 with an integrated magnet. The sub-pocket 530 may include the magnet 532 affixed to the interior of the of the sub-pocket 530 on the side closest to the wearer's body 520 without the wireless charger 531.

In some embodiments, the pocket-equipped article 510 may include an article of clothing, a backpack, a purse, a handbag, or some other article capable of being equipped with a pocket.

Reference throughout this specification to “one implementation,” “an implementation,” “some implementations,” “one embodiment,” “an embodiment,” or “some embodiments,” or “one or more embodiments” mean that a particular feature, structure, or characteristic described in connection with the implementation or embodiment is included in at least one implementation or embodiment. Thus, the appearances of the phrase “in one implementation” or “in an implementation” or other similar terms in various places throughout this specification are not necessarily all referring to the same implementation. In addition, the term “or” is intended to mean an inclusive “or” rather than an exclusive “or.” Moreover, the word “example” or a similar term are used herein to mean serving as an example, instance, or illustration. Any aspect or design described herein as an “example” is not necessarily to be construed as preferred or advantageous over other aspects or designs. Rather, use of the word “example” or a similar term is intended to present concepts in a concrete fashion.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A magnetic pocket for mobile devices comprising:
a pocket-equipped article;
a pocket disposed on the pocket-equipped article, the pocket having a top part and a bottom part, the top part of the pocket having an opening; and
a magnet, the magnet being enclosed in a material, wherein the material fully covers the magnet, and wherein the material is removably attached to the pocket disposed on the pocket-equipped article.

2. The magnetic pocket for mobile devices of claim 1, wherein the pocket-equipped article comprises at least one of:
an article of clothing,
a backpack,
a purse, or
a handbag.

3. The magnetic pocket for mobile devices of claim 1, wherein the pocket comprises the same material as the pocket-equipped article.

4. The magnetic pocket for mobile devices of claim 3, wherein the pocket further comprises an insulating material.

5. The magnetic pocket for mobile devices of claim 1, wherein the material enclosing the magnet augments the friction experienced by a charging apparatus and a mobile device disposed in the pocket.

6. The magnetic pocket for mobile devices of claim 1, wherein the material is removably attached to the pocket via at least one of: sewing stitches, iron-on adhesive, rivets, glue, adhesive, stapling, hook-and-loop, snap fasteners, grommets and lacing, zippers, pins, clips, magnets, buttons, and hooks.

7. A magnetic pocket for mobile devices comprising:
a pocket-equipped article;
a pocket disposed on the pocket-equipped article, the pocket having a top part and a bottom part, the top part of the pocket having an opening; and
a magnet, the magnet being enclosed in a material, wherein the material fully covers the magnet, and wherein the material is permanently attached to the pocket disposed on the pocket-equipped article.

8. The magnetic pocket for mobile devices of claim 7, wherein the pocket comprises the same material as the pocket-equipped article.

9. The magnetic pocket for mobile devices of claim 8, wherein the pocket further comprises an insulating material.

10. The magnetic pocket for mobile devices of claim 7, wherein the material enclosing the magnet augments the friction experienced by a charging apparatus and a mobile device disposed in the pocket.

11. The magnetic pocket for mobile devices of claim 7, wherein the material is permanently attached to the pocket via at least one of: sewing stitches, iron-on adhesive, rivets, glue, adhesive, stapling, hook-and-loop, snap fasteners, grommets and lacing, zippers, pins, clips, magnets, buttons, and hooks.

12. A magnetic pocket for mobile devices comprising:
a pocket-equipped article;
a pocket disposed on the pocket-equipped article, the pocket having a top part and a bottom part, the top part of the pocket having an opening;
a magnet, the magnet being enclosed in a material, wherein the material fully covers the magnet, and wherein the material attaches to the pocket disposed on the pocket-equipped article; and
a charging apparatus, the charging apparatus magnetically attaching to the magnet.

13. The magnetic pocket for mobile devices of claim 12, wherein, responsive to a mobile device being disposed in the pocket, the magnet concentrically aligns the charging apparatus with the mobile device.

14. The magnet of claim 12, wherein the magnet comprises a magnetic ring.

15. The magnetic ring of claim 14, wherein the magnetic ring improves electronic inductive resonance between the charging apparatus and a mobile device disposed in the pocket.

16. The charging apparatus of claim 12, wherein the charging apparatus is removably connected to an interior portion of the pocket.

17. The charging apparatus of claim 12, wherein the charging apparatus is permanently affixed to an interior portion of the pocket.

18. The charging apparatus of claim 12, further comprising a channel that connects the charging apparatus to an energy source.

19. The charging apparatus of claim 18, wherein at least a portion of the channel is disposed through one or more belt loops of the pocket-equipped article.

20. The charging apparatus of claim 18, wherein the energy source is disposed in at least one of:
an interior portion of the pocket-equipped article; or
an additional pocket.
